(19) United States
(12) Patent Application Publication
(10) Pub. No.: US 2012/0091094 A1
(43) Pub. Date: Apr. 19, 2012

(54) METHOD FOR FORMING NANOSTRUCTURE

(75) Inventor: Sheng-Ru Lee, Taipei (TW)

(73) Assignee: AUROTEK CORPORATION, Taipei City (TW)

(21) Appl. No.: 13/015,059

(22) Filed: Jan. 27, 2011

(30) Foreign Application Priority Data
Oct. 15, 2010 (TW) 99135172

(51) Int. Cl. C23F 1/00; B82Y 40/00

(52) U.S. Cl. 216/11; 977/888

(57) ABSTRACT

The present invention provides a method for forming a nanostructure. The method includes the steps of providing a substrate; forming a plurality of nanoparticles on the substrate; forming a film on the substrate and between every two adjacent nanoparticles of the nanoparticles; removing the nanoparticles; forming a resist layer on the film; performing a wet etching for removing the film and a portion of the substrate under the film to form a plurality of protruding portions; and removing the resist layer to expose the plurality of the protruding portions. The method of the present invention is performed without vacuum environment and photolithography, such that the method of the present invention is simple when compared with the prior art.

### CROSS-REFERENCE TO RELATED APPLICATIONS

The present application claims the benefit of priority from prior Taiwanese Patent Application No. 099135172 filed Oct. 15, 2010, the entire contents of which is incorporated herein by reference.

### BACKGROUND OF THE INVENTION

1. Field of the Invention

The present invention relates to methods for forming a nanostructure, and more particularly, to a method for forming a nanostructure by using nanoparticles.

2. Description of Related Art

Due to small volume, light weight and high light-emitting efficiency, light-emitting diodes are widely used in illumination and warning devices. However, light emitting from a light-emitting component of a light-emitting diode through a coupling component is radial emission, such that light from the light source fails to focus. Hence, it is important to uniform and optimize the light source. Currently, a patterned substrate is used for lowering epitaxial defects and increasing light extraction efficiency, and thus an epitaxial structure significantly influence yield of process and efficiency of a semiconductor light-emitting diode.

Please refer to FIG. 1A to FIG. 1F showing a method for forming a conventional nanostructure 1. As shown in FIG. 1A, a substrate 10 is provided in a vacuum environment and is formed with a silicon oxide layer 11 thereon. As shown in FIG. 1B, a photoresist layer 12 is coated on the substrate 10 and the silicon oxide layer 11, and a photolithography process is performed to form a plurality of pattern openings 120 on the photoresist layer 12, so as to expose the silicon layer 11 through the openings 120. As shown in FIG. 1C, the silicon oxide layer 11 in the openings 10 is removed by etching, so as to expose the substrate 10 from each opening 120. As shown in FIG. 1D, the photoresist layer 12 is removed. As shown in FIG. 1E, a wet etching is performed to remove a portion of the exposing substrate 10, and thus a plurality of trenches 100 are formed on the substrate 10. As shown in FIG. 1F and FIG. 1G, the silicon oxide layer 11 is removed, and a nanostructure 1 is thus formed.

Alternatively, as shown in FIG. 1E′, a wet etching is performed to remove a portion of the exposing substrate 10, so as to form a plurality of trenches 100′ on the substrate 10. As shown in FIGS. 1F′ and 1G′, the silicon oxide layer 11 is removed to form a nanostructure 1.

However, the above conventional methods need to be performed by photolithography process in vacuum, such that the process is complicated and the cost of equipments and facilities is expensive.

Therefore, there is a need to develop a novel method for forming a nanostructure.

### SUMMARY OF THE INVENTION

The present invention provides a method for forming a nanostructure. The method of the present invention includes the steps of providing a substrate; forming a plurality of nanoparticles on the substrate; forming a film on the substrate and between every two adjacent ones of the nanoparticles; removing the nanoparticles; forming a resist layer on the film; performing a wet etching for removing the film and a portion of the substrate under the film to form a plurality of protruding portions; and removing the resist layer to expose the plurality of protruding portions.

In the method of the present invention, the substrate is an aluminum oxide (Al₂O₃) substrate or a silicon substrate.

In the method of the present invention, the film includes a metal oxide, such as an aluminum oxide, or a metal nitride.

In the method of the present invention, the resist layer and the film are made of different materials.

In the method of the present invention, a ratio of a height to a width of the protruding portion is in a range from 0.25 to 0.5, and the protruding portion has a lattice plane.

In accordance with the present invention, the method further includes the step of performing a sintering process before performing the wet etching.

Accordingly, the nanostructure is formed without vacuum process and photolithography process in the present invention, and thus the method for forming nanostructure is simple and the cost is significantly reduced when compared with the prior art.

### BRIEF DESCRIPTION OF THE DRAWINGS

FIGS. 1A to 1F are schematic views showing the cross-section structures of a nanostructure formed by the conventional method, wherein FIG. 1E′ and FIG. 1F′ are in place of FIG. 1E and FIG. 1F, respectively, to illustrate another conventional embodiment;

FIG. 1G is a schematic view showing a portion of the structure in FIG. 1F;

FIG. 1G′ is a top view showing a portion of the structure in FIG. 1F′;

FIG. 2A to FIG. 2F are schematic views showing the cross-section structures of a nanostructure formed by the method of the present invention;

FIG. 2G is a top view of a portion of the structure in FIG. 2F; and

FIG. 2G′ shows another embodiment of FIG. 2G.

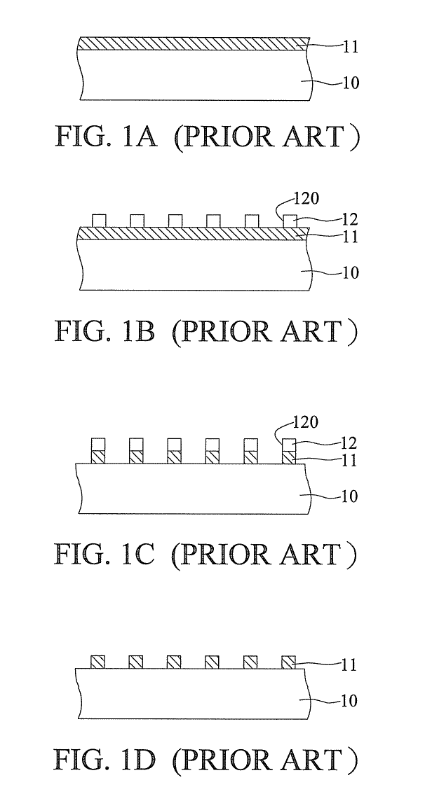

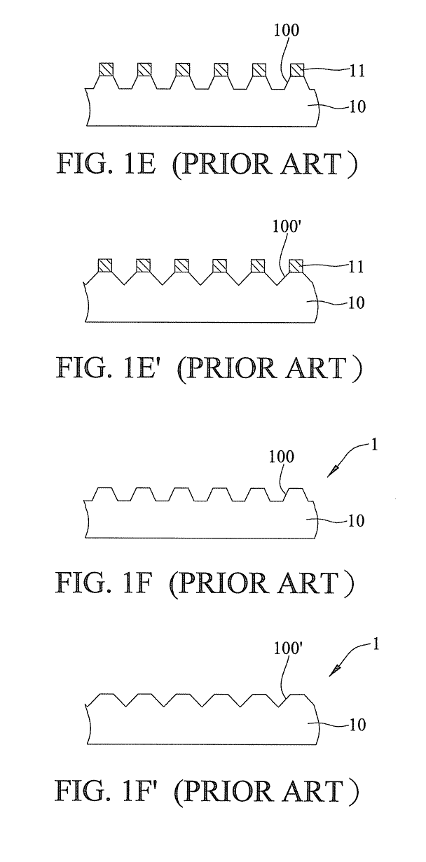

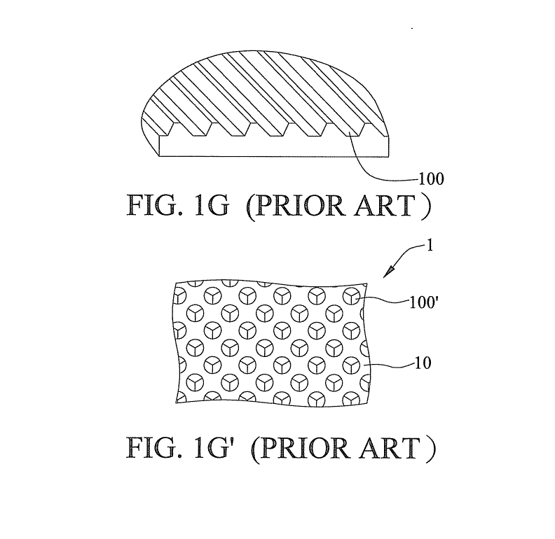

### DETAILED DESCRIPTION OF THE PREFERRED EMBODIMENTS

The detailed description of the present invention is illustrated by the following specific examples. Persons skilled in the art can conceive the other advantages and effects of the present invention based on the disclosure contained in the specification of the present invention.

In the present invention, the structure, scale and size shown in drawings are provided for persons skilled in the art to understand the disclosure of the present invention rather than limiting the practice of the present invention. The present invention covers any modifications, variations and adjustments of the structures which achieve effects and purposes of the present invention. In addition, the terms, such as “above”, “under”, “before”, “after”, “bottom”, “one” and “surface”, herein are used for illustrating the present invention rather than limiting the scope of the present invention.

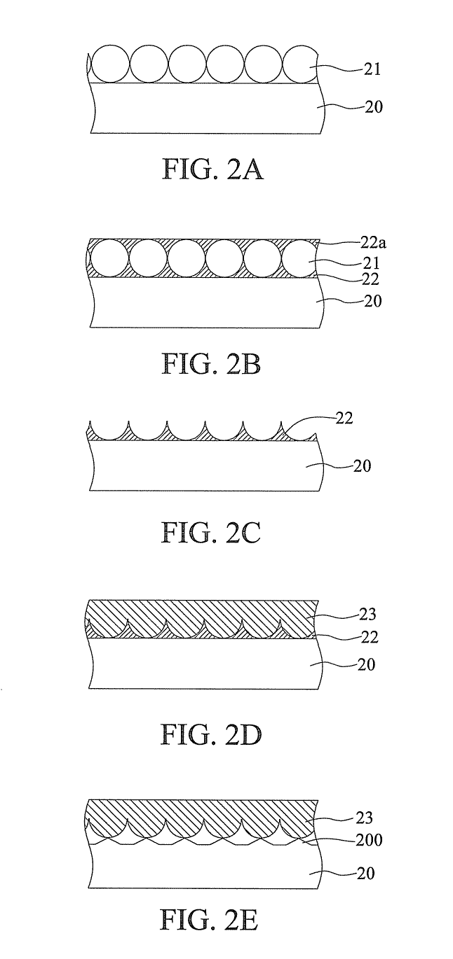

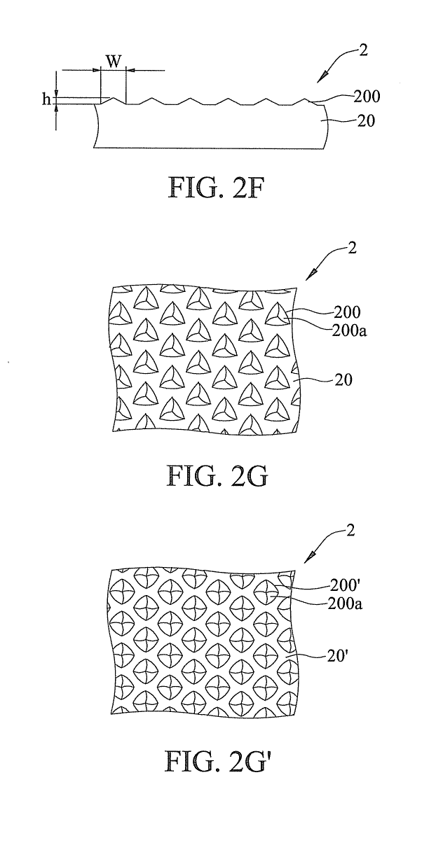

Referring to FIG. 2A to FIG. 2F, the method for forming a nanostructure of the present invention is illustrated. Particularly, the method is suitable for forming a nanostructure on an epitaxial substrate of a light-emitting diode.

As shown in FIG. 2A, a substrate 20 is provided, and a plurality of nanoparticles 21 are formed on the substrate 20. The nanoparticles, such as polystyrene particles, may be formed by emulsion polymerization. The substrate 20 may be an aluminum oxide (Al₂O₃) substrate or a silicon substrate.

As shown in FIG. 2B, a film 22 is formed on the substrate 20 and between every two adjacent nanoparticles 21. The material of the film 22 is a metal oxide or a metal nitride, such as oxides or nitrides of silicon, zinc, aluminum, chromium, titanium, indium, lead, tin, zirconium, hafnium, iron, vanadium, magnesium, tungsten, and etc. In the present embodiment, the material of the film 22 is aluminum oxide. Specifically, the film is made of one or more material selected from the group consisting of silicon oxide, zinc oxide, aluminum oxide, chromium oxide, titanium oxide, lead oxide, tin oxide, zirconium oxide, hafnium oxide, ferric oxide, vanadium oxide, magnesium oxide, tungsten oxide, zirconium titanate, lithium niobate and lithium tantalite. In addition, the film can further include one or more dopants selected from the group consisting of nitrogen, phosphorus and boron.

As shown in FIG. 2C, each nanoparticle 21 is removed. If the nanoparticles 21 are covered by the film 22, an upper portion of the film 22a are removed while removing the nanoparticles 21.

As shown in FIG. 2D, a resist layer 23 is formed on the film 22. The material of the resist layer 23 is a metal oxide or a metal nitride, such as oxides or nitrides of silicon, zinc, aluminum, chromium, titanium, indium, lead, tin, zirconium, hafnium, iron, vanadium, magnesium, tungsten, and etc. Specifically, the resist layer 23 is made of one or more material selected from the group consisting of silicon oxide, zinc oxide, aluminum oxide, chromium oxide, titanium oxide, lead oxide, tin oxide, zirconium oxide, hafnium oxide, ferric oxide, vanadium oxide, magnesium oxide, tungsten oxide, zirconium titanate, lithium niobate and lithium tantalite. In addition, the film can further include one or more dopants selected from the group consisting of nitrogen, phosphorus and boron. The material of the resist layer 23 is different from that of the film 22. In the present embodiment, the material of the resist layer 23 is silicon oxide.

As shown in FIG. 2E, a wet etching is performed to remove the film 22 and a portion of the substrate 20 under the film 22 so as to form a plurality of protruding portions 200 on the surface of the substrate 20. Each of the protruding portions 200 has a lattice plane 200a. To be more specific, as the contact portion between the resist layer 23 and the substrate 20 is the bottom of each nanoparticle 21, while performing etching, a portion of the substrate 20 is downwardly etched away. Thus, the top point of the protruding portion 200 is formed at the contact portion between the resist layer 23 and the substrate 20 (there may not be a physical contact between the resist layer 23 and the substrate 20). Further, the material of the resist layer 23 is porous, such that micro etching occurs to the resist layer 23 during etching. Due to the porous etching and the thickness of the resist layer 23, the protruding portions 200 are formed on the substrate 20. In addition, before performing the wet etching, a sintering process can be performed to solidify the resist layer 23.

As shown in FIG. 2F, the resist layer 23 is removed to expose each protruding portion 200, and thus the nanostructure 2 of the present invention is obtained, with the ration of the height h to the width w of the protruding portion 200 being about 0.25 to 0.5.

Referring to FIG. 2G and FIG. 2G′, different shapes of the protruding portion 200 are formed on different substrates 200, respectively. When the substrate 20 is made of aluminum oxide (Al₂O₃), the protruding portion 200 had three lattice planes as shown in FIG. 2G. When the substrate 20′ is made of silicon, the protruding portion 200′ has four lattice planes as shown in FIG. 2G′.

Accordingly, the method of the present invention is performed without vacuum environment and photolithography, such that the method of the present invention is simple and the cost thereof is significantly reduced in comparison with the conventional methods.

The invention has been described using exemplary preferred embodiments. However, it is to be understood that the scope of the invention is not limited to the disclosed arrangements. The scope of the claims, therefore, should be accorded the broadest interpretation, so as to encompass all such modifications and similar arrangements.

1. A method for forming a nanostructure, comprising the steps of:
providing a substrate;
forming a plurality of nanoparticles on the substrate;
forming a film on the substrate and between every two adjacent ones of the nanoparticles;
removing the nanoparticles;
forming a resist layer on the film;
performing a wet etching for removing the film and a portion of the substrate under the film to form a plurality of protruding portions; and
removing the resist layer to expose the plurality of protruding portions.

2. The method of claim 1, wherein the substrate is an aluminum oxide substrate or a silicon substrate.

3. The method of claim 1, wherein the film comprises a metal oxide or a metal nitride.

4. The method of claim 3, wherein the film comprises at least a dopant selected from a group consisting of nitrogen, phosphorus and boron.

5. The method of claim 1, wherein the resist layer is made of a metal oxide or a metal nitride.

6. The method of claim 1, wherein the resist layer is made of a silicon oxide.

7. The method of claim 1, wherein the resist layer and the film are made of different materials.

8. The method of claim 1, wherein a ratio of a height to a width of the protruding portion is in a range from 0.25 to 0.5.

9. The method of claim 1, wherein the protruding portion has a lattice plane.

10. The method of claim 1, further comprising a step of performing a sintering process before performing the wet etching.
